(19) United States
(12) Patent Application Publication
(10) Pub. No.: US 2026/0199901 A1
(43) Pub. Date: Jul. 16, 2026

(54) A SYSTEM AND METHOD FOR READING RADIO FREQUENCY IDENTIFICATION TAGS ASSOCIATED WITH IN-VITRO FERTILIZATION SAMPLES

(71) Applicant: ARCK TECHNOLOGIES INNOVATIONS PRIVATE LIMITED, Mumbai (IN)

(72) Inventor: Anil Pavithran Muzhangathu, Mumbai (IN)

(21) Appl. No.: 18/841,743

(22) PCT Filed: Jun. 11, 2024
(86) PCT No.: PCT/IB2024/055696

§ 371 Date: Aug. 27, 2024

(30) Foreign Application Priority Data
Aug. 21, 2023 (IN) 202321056038

(51) Int. Cl. B01L 3/00; G06K 7/10

(52) U.S. Cl. CPC B01L 3/545; G06K 7/10366; B01L 2300/022

(57) ABSTRACT

A system 100 for reading radio frequency identification tags associated with in-vitro fertilization samples is provided. The system includes a grooved viewing area 112 positioned under a microscope in a laminar hood for viewing a radio frequency identification tagged in-vitro fertilization sample. A zone 114 accommodates a glass plate in a parallel arrangement for the radio frequency identification tagged in-vitro fertilization sample placement. A metallic laminar plane 116 to establish an environment for radio frequency identification tag scanning. A radio frequency identification tag reader 118 connects to an antenna 120 through a wired connection. The antenna scans the radio frequency identification tag placed on the glass plate to capture radio frequency identification tag data regardless of the orientation and placement of the radio frequency identification tags thereby ensure capturing and tracking of radio frequency identification tag associated with in-vitro fertilization sample.

### EARLIEST PRIORITY DATE

This Application claims priority from a complete patent application filed in India having Patent Application No. 202321056038, filed on 21st day of August 2023 and titled “A SYSTEM AND METHOD FOR READING RADIO FREQUENCY IDENTIFICATION TAGS ASSOCIATED WITH IN-VITRO FERTILIZATION SAMPLES” and a PCT Application no. PCT/IB2024/055696 filed on 11th day of June 2024, and titled “A SYSTEM AND METHOD FOR READING RADIO FREQUENCY IDENTIFICATION TAGS ASSOCIATED WITH IN-VITRO FERTILIZATION SAMPLES.”

### FIELD OF INVENTION

Embodiments of the present disclosure relate to the field of in-vitro fertilization, and more particularly, a system and a method for reading radio frequency identification tags associated with in-vitro fertilization samples.

### BACKGROUND

During in-vitro fertilization (IVF), it is important to ensure an accurate matching and tracking of sperm and oocytes to avoid sample mismatches. The sample mismatches may occur when genetic material from one patient is unintentionally mixed with that of another, leading to serious consequences and ethical concerns. To address this issue, several electronic witnessing systems have been developed and are currently available in the market. The in-vitro fertilization radio frequency identification (IVF RFID) tag witnessing system is one such approach, that typically employs RFID (Radio-Frequency Identification) technology to enhance the safety and accuracy of in-vitro fertilization (IVF) treatments.

One major limitation of the existing in-vitro fertilization radio frequency identification (IVF RFID) tag witnessing system is the inability to function in the presence of metallic objects. The signals emitted by RFID tags are disrupted near metals, leading to signal loss and less tracking accuracy. This poses a significant problem as many components and tools used in IVF procedures are made of metal, thus increasing the chances of the occurrence of errors or mismatches.

Further, another in-vitro fertilization radio frequency identification (IVF RFID) tag witnessing system includes a non-metallic unit with a heater assembly. The drawback of such an electronic witnessing system is that it requires the incorporation of additional hardware, such as the heating assembly which is placed in a laminar flow hood on the existing heater assembly, which may introduce complexity. Furthermore, in the occurrence of any hardware malfunctions and unwanted mismatch, then the complete electronic witnessing system fails.

Another limitation of the in-vitro fertilization radio frequency identification (IVF RFID) tag witnessing system is the tag orientation. If the orientation of the RFID tags and the position of the RFID reader are not aligned properly, leads to incomplete or inaccurate scanning of the RFID tags on samples. Consequently, leading to the risk of sample mismatches.

Hence, there is a need for an improved system and method for reading radio frequency identification tags associated with in-vitro fertilization samples which addresses the aforementioned issue(s).

### OBJECTIVE OF THE INVENTION

An objective of the invention is to scan a radio frequency identification tag associated with an in-vitro fertilization sample regardless of orientation and placement of the radio frequency identification tag.

Another objective of the invention is to scan the radio frequency identification tag associated with the in-vitro fertilization sample by incorporating an antenna directly onto the grooved viewing area of a microscope in a laminar flow hood, thus minimizing the necessity for additional hardware.

### BRIEF DESCRIPTION

In accordance with an embodiment of the present disclosure, a system for reading radio frequency identification tags associated with in-vitro fertilization samples is provided. The system includes a grooved viewing area positioned under a microscope in a laminar hood. The grooved viewing area is adapted for viewing a radio frequency identification tagged in-vitro fertilization sample. The in-vitro fertilization sample includes at least one biological sample selected from a group consisting of sperm, oocyte, and embryo for in-vitro fertilization process. The grooved viewing area includes a zone adapted to accommodate a glass plate in a parallel arrangement for the radio frequency identification tagged in-vitro fertilization sample placement. The system includes a metallic laminar plane surrounding the grooved viewing area. The metallic laminar plane is adapted to establish an environment for radio frequency identification tag scanning. The environment is free from contaminants, interference, and external factors that affect the radio frequency identification tag scanning. The system includes a radio frequency identification tag reader positioned in proximity to the grooved viewing area on the metallic laminar plane. The radio frequency identification tag reader is adapted to connect to an antenna through a wired connection. The antenna is positioned within the groove of the viewing area and beneath the glass plate. The antenna is configured to scan the radio frequency identification tag placed on the glass plate to capture radio frequency identification tag data. The radio frequency identification tag reader is further configured to scan the radio frequency identification tagged in-vitro fertilization sample regardless of the orientation and placement of the radio frequency identification tags thereby ensure capturing and tracking of radio frequency identification tag associated with in-vitro fertilization sample.

In accordance with another embodiment of the present disclosure, a method for reading radio frequency identification tags associated with in-vitro fertilization samples is provided. The method includes viewing, by a grooved viewing area, a radio frequency identification tagged in-vitro fertilization sample. In-vitro fertilization sample includes at least one biological sample selected from a group consisting of sperm, oocyte, and embryo for in-vitro fertilization process. The method includes accommodating, by a zone, a glass plate in a parallel arrangement for the radio frequency identification tagged in-vitro fertilization sample placement. The method includes establishing, by a metallic laminar plane, an environment for radio frequency identification tag scanning. The environment is free from contaminants, interference, and external factors that affect the radio frequency identification tag scanning. The method includes scanning, by an antenna, the radio frequency identification tag placed on the glass plate to capture radio frequency identification tag data. The antenna is positioned within the groove of the viewing area and beneath the glass plate and connected to a radio frequency identification tag reader through a wired connection. The method includes scanning, by the radio frequency identification tag reader, the radio frequency identification tagged in-vitro fertilization sample regardless of the orientation and placement of the radio frequency identification tags thereby ensure capturing and tracking of radio frequency identification tag associated with in-vitro fertilization sample.

To further clarify the advantages and features of the present disclosure, a more particular description of the disclosure will follow by reference to specific embodiments thereof, which are illustrated in the appended figures. It is to be appreciated that these figures depict only typical embodiments of the disclosure and are therefore not to be considered limiting in scope. The disclosure will be described and explained with additional specificity and detail with the appended figures.

### BRIEF DESCRIPTION OF THE DRAWINGS

The disclosure will be described and explained with additional specificity and detail with the accompanying figures in which:

FIG. 1 is a block diagram representation of a system for reading radio frequency identification tags associated with in-vitro fertilization samples in accordance with an embodiment of the present disclosure; and

FIG. 2 illustrates a flow chart representing the steps involved in a method for reading radio frequency identification tags associated with in-vitro fertilization samples in accordance with an embodiment of the present disclosure.

Further, those skilled in the art will appreciate that elements in the figures are illustrated for simplicity and may not have necessarily been drawn to scale. Furthermore, in terms of the construction of the device, one or more components of the device may have been represented in the figures by conventional symbols, and the figures may show only those specific details that are pertinent to understanding the embodiments of the present disclosure so as not to obscure the figures with details that will be readily apparent to those skilled in the art having the benefit of the description herein.

### DETAILED DESCRIPTION

For the purpose of promoting an understanding of the principles of the disclosure, reference will now be made to the embodiment illustrated in the figures and specific language will be used to describe them. It will nevertheless be understood that no limitation of the scope of the disclosure is thereby intended. Such alterations and further modifications in the illustrated system, and such further applications of the principles of the disclosure as would normally occur to those skilled in the art are to be construed as being within the scope of the present disclosure.

The terms “comprises”, “comprising”, or any other variations thereof, are intended to cover a non-exclusive inclusion, such that a process or method that comprises a list of steps does not include only those steps but may include other steps not expressly listed or inherent to such a process or method. Similarly, one or more devices or subsystems or elements or structures or components preceded by “comprises . . . a” does not, without more constraints, preclude the existence of other devices, sub-systems, elements, structures, components, additional devices, additional sub-systems, additional elements, additional structures or additional components. Appearances of the phrase “in an embodiment”, “in another embodiment” and similar language throughout this specification may, but not necessarily do, all refer to the same embodiment.

Unless otherwise defined, all technical and scientific terms used herein have the same meaning as commonly understood by those skilled in the art to which this disclosure belongs. The system, methods, and examples provided herein are only illustrative and not intended to be limiting.

In the following specification and the claims, reference will be made to a number of terms, which shall be defined to have the following meanings. The singular forms “a”, “an”, and “the” include plural references unless the context clearly dictates otherwise.

Embodiments of the present disclosure relate to a system for reading radio frequency identification tags associated with in-vitro fertilization samples. The system includes a grooved viewing area positioned under a microscope in a laminar hood. The grooved viewing area is adapted for viewing a radio frequency identification tagged in-vitro fertilization sample. The in-vitro fertilization sample includes at least one biological sample selected from a group consisting of sperm, oocyte, and embryo for in-vitro fertilization process. The grooved viewing area includes a zone adapted to accommodate a glass plate in a parallel arrangement for the radio frequency identification tagged in-vitro fertilization sample placement. The system includes a metallic laminar plane surrounding the grooved viewing area. The metallic laminar plane is adapted to establish an environment for radio frequency identification tag scanning. The environment is free from contaminants, interference, and external factors that affect the radio frequency identification tag scanning. The system includes a radio frequency identification tag reader positioned in proximity to the grooved viewing area on the metallic laminar plane. The radio frequency identification tag reader is adapted to connect to an antenna through a wired connection. The antenna is positioned within the groove of the viewing area and beneath the glass plate. The antenna is configured to scan the radio frequency identification tag placed on the glass plate to capture radio frequency identification tag data. The radio frequency identification tag reader is further configured to scan the radio frequency identification tagged in-vitro fertilization sample regardless of the orientation and placement of the radio frequency identification tags thereby ensure capturing and tracking of radio frequency identification tag associated with in-vitro fertilization sample.

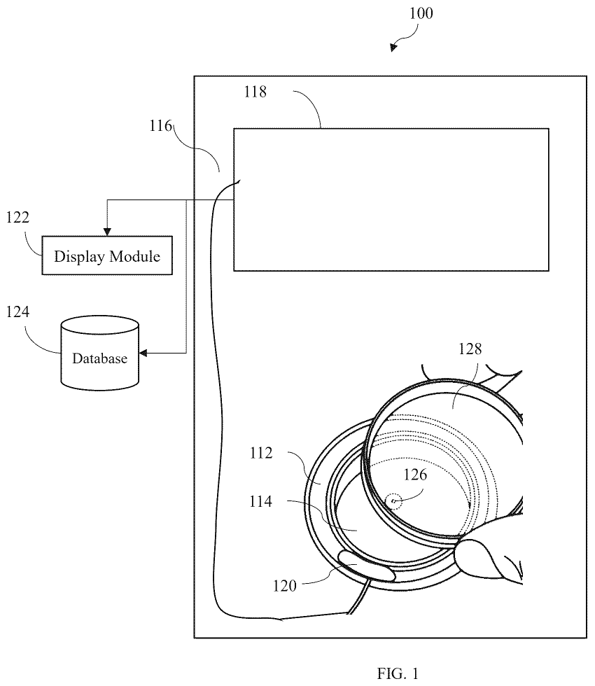

FIG. 1 is a block diagram of a system for reading radio frequency identification tags associated with in-vitro fertilization samples in accordance with an embodiment of the present disclosure. The system 100 includes a grooved viewing area 112 positioned under a microscope (not shown in FIG. 1) in a laminar hood (not shown in FIG. 1). The grooved viewing area 112 is adapted for viewing a radio frequency identification tagged in-vitro fertilization sample. The in-vitro fertilization sample includes at least one biological sample selected from a group consisting of sperm, oocyte, and embryo carefully placed into a specialized container 128, for example a culture dish. The specialized container 128 is equipped with a corresponding radio frequency identification tag. Typically, radio frequency identification tag is an electronic tag that exchanges data with a radio frequency identification (RFID) reader by using radio waves. The radio frequency identification tag is affixed to the culture dish, that stores predefined data to indicate a unique identity of biological sample.

In an embodiment, predefined data include the unique identity of biological sample, patient information, collection data and time, sample details and the like.

In one embodiment, the grooved viewing area 112 is circular in shape, however it may adopt any suitable shape as necessary. The primary intent of the grooved viewing area 112 is to accommodate the culture dish and provide optimal visibility of in-vitro fertilization sample.

Further, the grooved viewing area 112 includes a zone 114 adapted to accommodate a glass plate in a parallel arrangement for the radio frequency identification tagged in-vitro fertilization sample placement. The glass plate is positioned to accommodate the placement of the culture dish containing radio frequency identification tagged in-vitro fertilization sample. By placing the culture dish on the glass plate, the radio frequency identification tagged in-vitro fertilization sample may be observed under the microscope. The glass plate is transparent thereby facilitating visual observation of the radio frequency identification tagged in-vitro fertilization sample during scanning.

The system 100 includes a metallic laminar plane 116 surrounding the grooved viewing area 112. The metallic laminar plane 116 is adapted to establish an environment for radio frequency identification tag scanning. The environment is free from contaminants, interference, and external factors that affect the radio frequency identification tag scanning. The metallic laminar plane is selectively heated or non-heated.

In an embodiment, metallic laminar plane 116 is rectangular in shape and may be made of materials example, steel, nickel, aluminum and the like. The choice of material for the metallic laminar plane 116 depends on factors like electromagnetic shielding requirements, cost and the like.

The system 100 includes a radio frequency identification tag reader 118 positioned in proximity to the grooved viewing area 112 on the metallic laminar plane 116. The radio frequency identification tag reader 118 is a device used to communicate with radio frequency identification tag on the in-vitro fertilization sample through an antenna 120. The radio frequency identification tag reader 118 sends signal to the radio frequency identification tags and receives the responses from the tags. The radio frequency identification tag reader 118 is adapted to connect to the antenna 120 through a wired connection. The antenna 120 is positioned within the groove of the viewing area and beneath the glass plate. Examples for antenna 120 includes but not limited to patch antenna, micro strip antenna and the like. The choice and shape of antenna 120 depends on factors like the frequency range of operation, size of the antenna and the like. When the radio frequency identification tag reader 118 sends out the signal, the antenna 120 generates an electromagnetic field, which powers up the radio frequency identification tag 126 on the in-vitro fertilization within its range. The radio frequency identification tag reader 118 scans the radio frequency identification tagged in-vitro fertilization sample regardless of the orientation and placement of the radio frequency identification tags. The radio frequency identification tag 126 then responds by sending back stored predefined data to the radio frequency identification tag reader 118. The system 100 includes a display module 122 connected to the radio frequency identification tag reader 118. The display module 122 is configured to real-time visualization of radio frequency identification tag data, thereby ensuring capturing and tracking of radio frequency identification tag 126 associated with in-vitro fertilization sample.

Further, the system 100 includes a database 124 operatively coupled to the radio frequency identification tag reader 118. The database 124 is configured to store captured radio frequency identification tag data with at least one in-vitro fertilization sample.

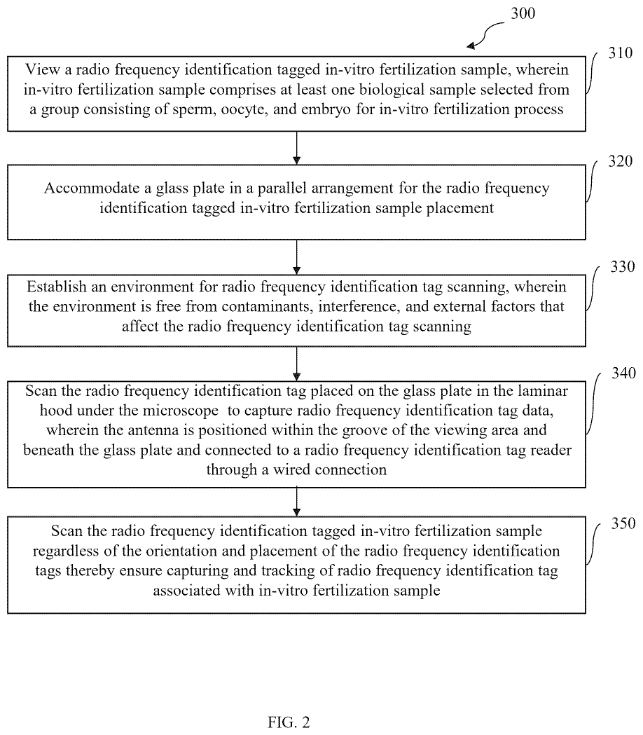

FIG. 2 illustrates a flow chart representing the steps involved in a method 300 for reading radio frequency identification tags associated with in-vitro fertilization samples in accordance with an embodiment of the present disclosure. The method 300 includes viewing, by a grooved viewing area in a laminar hood, a radio frequency identification tagged in-vitro fertilization sample. In-vitro fertilization sample includes at least one biological sample selected from a group consisting of sperm, oocyte, and embryo for in-vitro fertilization process in step 310. In in-vitro fertilization procedures, the in-vitro fertilization sample includes at least one biological sample placed into a specialized container, for example a culture dish. The specialized container is equipped with a corresponding radio frequency identification tag. The radio frequency identification tag is affixed to the portion containing the biological sample like sperm, oocyte or embryo, that stores predefined data to indicate a unique identity of biological sample.

In an embodiment, predefined data include the unique identity of biological sample, patient information, collection data and time, sample details and the like.

The method includes accommodating, by a zone, a glass plate in a parallel arrangement for the radio frequency identification tagged in-vitro fertilization sample placement in step 320. The specialized container with the biological sample and its corresponding radio frequency identification tag, is placed onto this glass plate. This arrangement allows the radio frequency identification tagged in-vitro fertilization sample to be observed through the microscope, providing clear visibility for further processing.

The method includes establishing, by a metallic laminar plane, an environment for radio frequency identification tag scanning. The environment is free from contaminants, interference, and external factors that affect the radio frequency identification tag scanning in step 330.

The method includes scanning, by an antenna, the radio frequency identification tag placed on the glass plate to capture radio frequency identification tag data. The antenna is positioned within the groove of the viewing area and beneath the glass plate and connected to a radio frequency identification tag reader through a wired connection in step 340. Examples for antenna includes but not limited to patch antenna, micro strip antenna and the like. The choice and shape of antenna depends on factors like the frequency range of operation, size of the antenna and the like. When the radio frequency identification tag reader sends out the signal, the antenna generates an electromagnetic field, which powers up the radio frequency identification tag on the in-vitro fertilization within its range.

The method includes scanning, by the radio frequency identification tag reader, the radio frequency identification tagged in-vitro fertilization sample regardless of the orientation and placement of the radio frequency identification tags thereby ensure capturing and tracking of radio frequency identification tag associated with in-vitro fertilization sample in step 350. The radio frequency identification tag then responds by sending back stored predefined data to the radio frequency identification tag reader. The system includes a display module connected to the radio frequency identification tag reader. The display module is configured to real-time visualization of radio frequency identification tag data.

Various embodiments of the system and method for reading radio frequency identification tags associated with in-vitro fertilization samples as described above read the radio frequency identification tag on the in-vitro fertilization samples regardless of the orientation and placement of the radio frequency identification tags. Further, the system eliminates the need for additional hardware, which is often used in available setups for in-vitro fertilization sample tracking. The reduction in hardware components simplifies the overall setup, reduces maintenance requirements, and lowers costs. The system employs a modified radio frequency tag reader, which has the antenna which scans the RFID tags, and is situated within the grooved viewing area. An optimized arrangement of the antenna enhances the accuracy of RFID tag reading and eliminates interference,

It will be understood by those skilled in the art that the foregoing general description and the following detailed description are exemplary and explanatory of the disclosure and are not intended to be restrictive thereof.

While specific language has been used to describe the disclosure, any limitations arising on account of the same are not intended. As would be apparent to a person skilled in the art, various working modifications may be made to the method in order to implement the inventive concept as taught herein.

The figures and the foregoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, the order of processes described herein may be changed and are not limited to the manner described herein. Moreover, the actions of any flow diagram need not be implemented in the order shown; nor do all of the acts need to be necessarily performed. Also, those acts that are not dependent on other acts may be performed in parallel with the other acts. The scope of embodiments is by no means limited by these specific examples.

We claim:

1. A system for reading radio frequency identification tags associated with in-vitro fertilization samples comprising:
a grooved viewing area positioned under a microscope in a laminar hood, wherein the grooved viewing area is adapted for viewing a radio frequency identification tagged in-vitro fertilization sample, wherein in-vitro fertilization sample comprises at least one biological sample selected from a group consisting of sperm, oocyte, and embryo for in-vitro fertilization process;
characterized in that,
wherein the grooved viewing area comprises:
a zone adapted to accommodate a glass plate in a parallel arrangement for the radio frequency identification tagged in-vitro fertilization sample placement;
a metallic laminar plane surrounding the grooved viewing area, wherein the metallic laminar plane is adapted to establish an environment for radio frequency identification tag scanning, wherein the environment is free from contaminants, interference, and external factors that affect the radio frequency identification tag scanning;
a radio frequency identification tag reader is positioned in proximity to the grooved viewing area on the metallic laminar plane, wherein radio frequency identification tag reader is adapted to:
connect to an antenna through a wired connection, wherein the antenna is positioned within the groove of the viewing area and beneath the glass plate, wherein the antenna is configured to scan the radio frequency identification tag placed on the glass plate in the laminar hood under the microscope to capture radio frequency identification tag data; and
scan the radio frequency identification tagged in-vitro fertilization sample regardless of the orientation and placement of the radio frequency identification tags thereby ensure capturing and tracking of radio frequency identification tag associated with in-vitro fertilization sample.

2. The system as claimed in claim 1, wherein radio frequency identification tag stores predefined data to indicate a unique identity of biological sample.

3. The system as claimed in claim 1, wherein the radio frequency identification tag is affixed to a location on a specialized container, wherein the specialized container is adapted to house the in-vitro fertilization sample.

4. The system as claimed in claim 1, the metallic laminar plane is selectively heated or non-heated.

5. The system as claimed in claim 1, wherein the glass plate is transparent thereby facilitating visual observation of the radio frequency identification tagged in-vitro fertilization sample during scanning.

6. The system as claimed in claim 1, comprising a database operatively coupled to the radio frequency identification tag reader, wherein the database is configured to store captured radio frequency identification tag data with at least one in-vitro fertilization sample.

7. The system as claimed in claim 1, comprising a display module connected to the radio frequency identification tag reader, wherein the display module is configured to real-time visualization of radio frequency identification tag data.

8. A method for reading radio frequency identification tags associated with in-vitro fertilization samples comprising:
viewing, by a grooved viewing area in a laminar hood, a radio frequency identification tagged in-vitro fertilization sample, wherein in-vitro fertilization sample comprises at least one biological sample selected from a group consisting of sperm, oocyte, and embryo for in-vitro fertilization process;
characterized in that,
accommodating, by a zone, a glass plate in a parallel arrangement for the radio frequency identification tagged in-vitro fertilization sample placement;
establishing, by a metallic laminar plane, an environment for radio frequency identification tag scanning, wherein the environment is free from contaminants, interference, and external factors that affect the radio frequency identification tag scanning;
scanning, by an antenna, the radio frequency identification tag placed on the glass plate in the laminar hood under the microscope to capture radio frequency identification tag data, wherein the antenna is positioned within the groove of the viewing area and beneath the glass plate and connected to a radio frequency identification tag reader through a wired connection; and
scanning, by the radio frequency identification tag reader, the radio frequency identification tagged in-vitro fertilization sample regardless of the orientation and placement of the radio frequency identification tags thereby ensure capturing and tracking of radio frequency identification tag associated with in-vitro fertilization sample.
